(19) United States
(12) Patent Application Publication
(10) Pub. No.: US 2026/0309593 A1
(43) Pub. Date: Oct. 8, 2026

(54) SCENT COLLECTION SYSTEM AND METHOD

(71) Applicant: Paul Coley, Tallahassee, FL (US)

(72) Inventor: Paul Coley, Tallahassee, FL (US)

(21) Appl. No.: 19/710,844

(22) Filed: Jun. 17, 2026

Related U.S. Application Data
(63) Continuation-in-part of application No. 18/128,237, filed on Mar. 30, 2023, now Pat. No. 12,034,665.

(51) Int. Cl. G01N 1/24

(52) U.S. Cl. CPC G01N 1/24; G01N 2001/245

(57) ABSTRACT

A system and method of collecting scent, depositing the scent on a scent pad, and storing the scent pad within a scaled scent jar. A collection hood is provided. A vacuum is provided on the rearward portion of the collection hood. The vacuum is configured to draw air into the collection hood. A scent pad is removably secured across an open portion of the collection hood. Air drawn into the collection hood is pulled through the scent pads—whereby airborne scent particles become trapped in the scent pad.

### CROSS-REFERENCES TO RELATED APPLICATIONS

This application claims priority to U.S. application Ser. No. 18/128,237. The parent application was filed on Mar. 28, 2023. It listed the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of scent collection and preservation. More specifically, the invention comprises a system for concentrating and collecting scent on a scent pad, then sealing the scent pad within a scent jar without the scent pad being touched by human hands.

### 2. Description of the Related Art.

Scent collection involves the depositing of scent on a scent pad. This is often accomplished by wiping the scent pad on a collection object. The scent pad may then be analyzed for various purposes—such as the detection of certain chemical agents indicating the presence of explosives or illicit narcotics.

Scent pads are also used as part of an animal tracking process. A scent pad can be provided to a trained tracking animal—typically a Bloodhound—and the animal will then remember the scent and detect and follow that scent in the environment. The present invention is useful in a wide variety of scent collection endeavors. However, these descriptions pertain primarily to scent detection for use with tracking animals.

Bloodhounds are used to track people that need to be found. It is common to think of Bloodhounds being used to track escaped convicts, but they are also used to find lost children and elderly persons suffering from dementia. In any case, it is important to provide the Bloodhound with a sample of the scent to be tracked. Traditionally this meant presenting the dog with a piece of clothing the target person had recently worn.

A much better result can be obtained by collecting and preserving a scent sample for a person before the person becomes a search target. A scent pad can be wiped over the person's body, then sealed within a chamber for future use. The chamber is typically called a “scent jar,” which may be a conventional glass jar or some other type of vessel. Most such collected samples are preserved but never used. However, if a person for whom a sample has been collected goes missing, the collected scent pad is removed and used with a tracking animal.

The traditional methods are effective, but the collected scent is often contaminated by the persons doing the collecting. Gloves are usually worn. Even so, some of the scent of the collecting person will often be trapped on the scent pad while the scent pad is being applied to the subject and then sealed within the scent jar. A Bloodhound's nose is incredibly sensitive—having nearly 300 million olfactory receptors, Contamination of the scent signal is undesirable, since the dog is likely to perceive the scent of the intended target individual mixed with the “contamination scent” of the person or persons doing the collecting.

It is desirable to provide an Improved scent collecting system that minimizes contamination and enhances the collection of the scent of the target subject. The present invention provides such a system.

### BRIEF SUMMARY OF THE PRESENT INVENTION

The present invention comprises a system and method of collecting scent, depositing the scent on a scent pad, and storing the scent pad within a sealed scent jar. A collection hood is provided. A vacuum is provided on the rearward portion of the collection hood. The vacuum is configured to draw air into the collection hood. A scent pad is removably secured across an open portion of the collection hood. Air drawn into the collection hood is pulled through the scent pads —whereby airborne scent particles become trapped in the ascent pad.

The collection hood includes a jar receiver. A scent jar is engaged with this jar receiver, with the scent jar being open to the interior of the collection hood. Once the collection of scent is completed, the scent pad is pushed into the interior of the collection hood and down into the scent jar. The scent jar is then removed from the collection hood and sealed, with the scent pad inside.

### BRIEF DESCRIPTION OF THE SEVERAL VIEWS OF THE DRAWINGS

FIG. 1 is an exploded perspective view, showing the main components of an embodiment of the present invention.

FIG. 2 is an exploded side elevation view, showing the embodiment of FIG. 1.

FIG. 3 is a sectional elevation view, showing the operation of the embodiment of FIG. 1.

FIG. 4 is a sectional elevation view, showing the operation of the embodiment of FIG. 1.

FIG. 5 is a sectional elevation view, showing the operation of the embodiment of FIG. 1.

FIG. 6 is an elevation view w cutaway, showing a scent pad secured within a scent jar.

FIG. 7 is an exploded perspective view, showing the rear grate and the collection hood.

FIG. 8 is an exploded perspective view, showing the configuration of FIG. 7 with the addition of the front grate.

FIG. 9 is an exploded perspective view, showing how the grates capture a scent pad.

FIG. 10 is an exploded perspective view, showing the installation of a scent pad.

FIG. 11 is an exploded perspective view, showing the installation of a scent pad. side elevation view with a cutaway, showing an embodiment of the present invention.

### REFERENCE NUMERALS IN THE DRAWINGS

10 scent collection system
12 vacuum
14 intake
16 mounting ring
18 collection hood
20 scent jar
22 rear grate
24 scent pad
26 front grate
28 vacuum receiver
30 jar receiver
32 vacuum opening
34 jar opening
36 hatch opening
38 hatch
40 pivot
42 opening
44 lateral slot
46 lateral slot
48 opening
50 push rod
52. lid
54 forward opening
56 side slot
58 side slot
60 central slot
62 vertical retainer
64 vertical retainer
66 handle
68 grate opening
70 descending tab
72 descending tab
74 forward tab
76 central tab
78 lateral side
80 lateral side
82 descending central tab
84 forward edge
86 lateral side
88 lateral side
90 handle

### DETAILED DESCRIPTION OF THE INVENTION

The following descriptions pertain to embodiments configured for scent collection where the intention is to subsequently use the collected scent with tracking animals. Other embodiments can be created for use with explosive detection equipment or other applications. Having read these descriptions, many other embodiments will occur to those skilled in the art. Thus, the scope of the Invention should be fixed by the claims rather than the embodiments described.

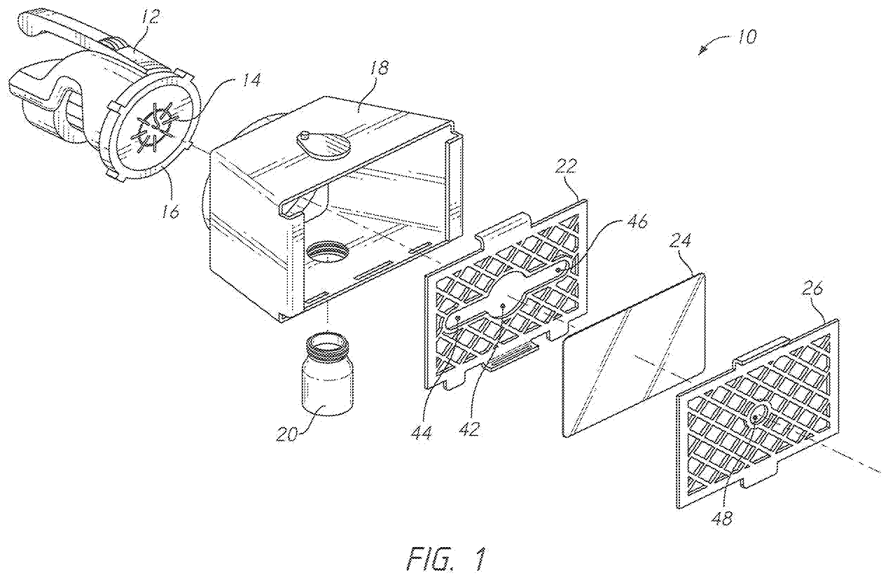

FIG. 1 presents an exploded view depicting the major components of the invention. Vacuum 12 is connected to the second end of collection hood is. When energized, the vacuum pulls air in through the open first end of the collection hood. Scent pad 24 is sandwiched between rear grate 22 and front grate 26. The assembly of rear grate 22, scent pad 24, and front grate 26 is positioned across the open first end of collection hood 18. The grates 22, 26 have many openings, but also have sufficient solid structure to grip and hold the scent pad. As those skilled in the art will realize, the air being drawn in through the open first end of collection hood 18 will be drawn through scent pad 24.

Scent pads are made in a variety of ways using differing materials. However, in general, they are a porous material including closely packed fibers. When air is drawn through (or around) a scent pad some of the airborne particles will adhere to the material of the scent pad and remain there. Thus, the operation of the device in FIG. 1 will tend to concentrate airborne particles in the vicinity in scent pad 24. Scent jar 20 is also preferably connected to collection hood 18. The scent jar is used to secure the scent pad once the collection process is completed.

The grates 22,26 are provided with openings that facilitate the removal of the scent pad. Front grate 26 includes opening 48. Rear grate 22 includes a relatively larger opening 42 and lateral slot 44.

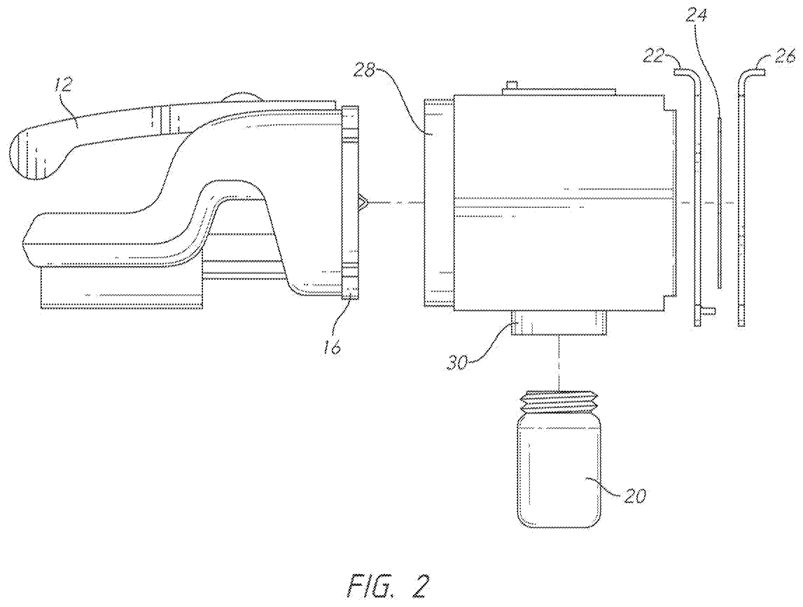

FIG. 2 provides an elevation view through the same assembly. Mounting ring 16 on vacuum 12 selectively attaches the vacuum to ring receiver 28 on the rear of the collection hood. The threaded upper portion of scent jar 20 threads into jar receiver 30 on the bottom of the collection hood—thereby selectively attaching the scent jar to the collection hood as well.

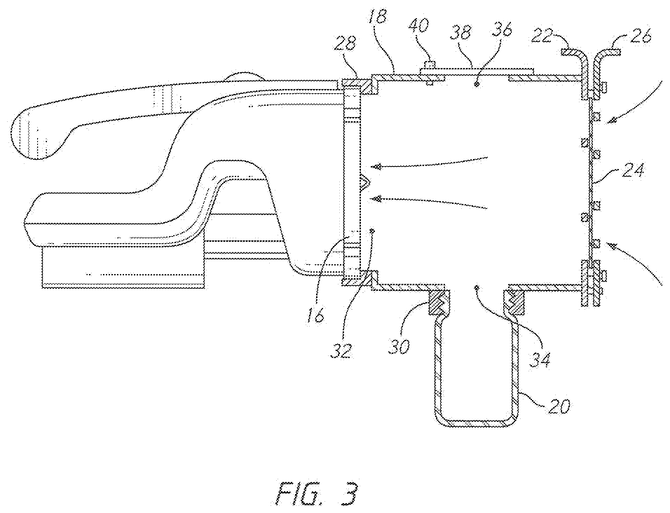

FIG. 3 provides a sectional elevation view through the same assembly in an assembled: state. Scent pad 24 is secured across the open end of the collection hood—held between rear grate 22 and front grate 26. The grates are secured to the collection hood, as will be explained in more detail subsequently. When the vacuum is activated air is drawn into the collection hood through scent pad 24. Scent particles in the air are thereby trapped within the fibers of the scent pad.

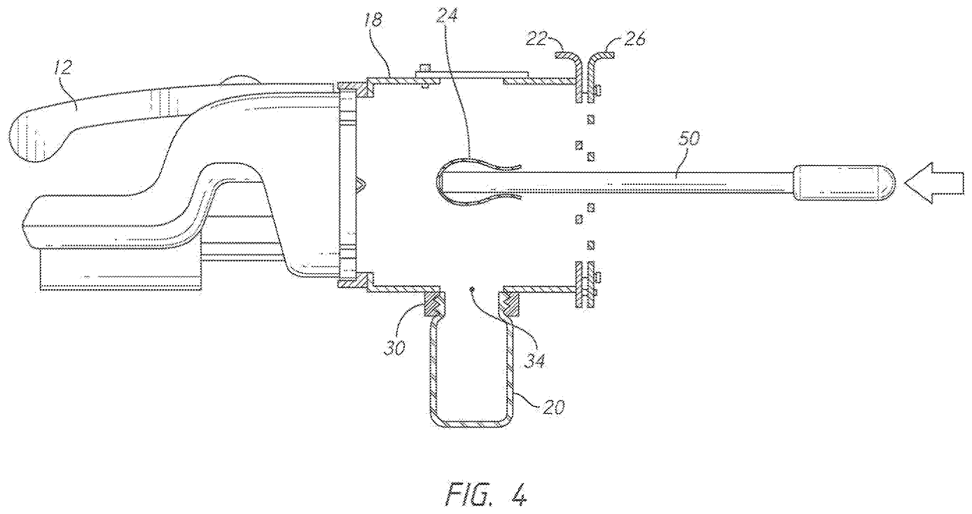

FIGS. 4-6 describe the process of securing the scent pad in a scent jar while minimizing the risk of external contamination. The user turns off the vacuum once it has been run for a sufficient period to load the scent pad. In FIG. 4, push rod 50 is used to push scent pad 24 to the rear of grates 22, 26. Push rod 50 is pushed through opening 48 in the front grate and the opening 42 in the rear grate. The thin and flexible scent pad tends to fold around the end of the push rod. Lateral slot 44 in rear grate 22 (see FIG. 1) allows the scent pad to more easily push through the rear grate,

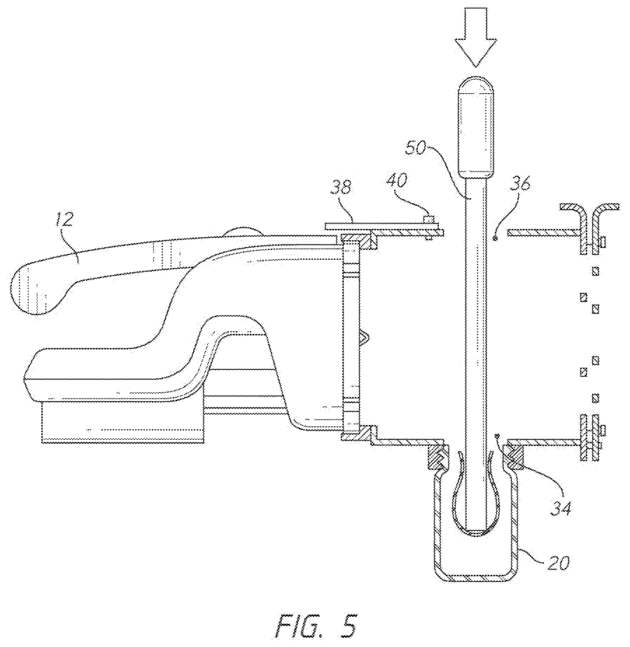

The user next withdraws the push rod back out the front of the collection hood, leaving the scent pad in the interior of the collection hood. FIG. 5 shows the next step in the process. The user pivots hatch 38 around pivot 40 in order to provide access to hatch opening 36. The user next inserts push rod 50 through the opening 36 and uses the end of the push rod to push the scent pad down through jar opening 34 and into scent jar 20.

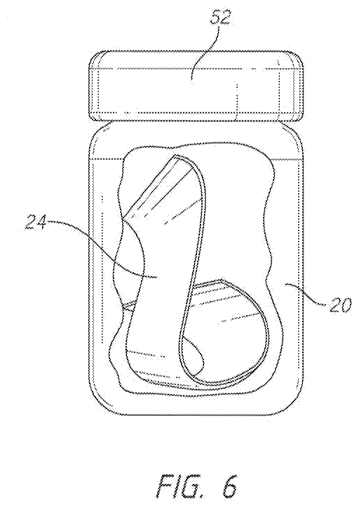

In FIG. 6 the user has unscrewed the scent jar from the collection hood and screwed lid 52 onto the scent jar, thereby securing scent pad 24 in the scent jar. The scent pad is sealed within the scent jar, where it can remain uncontaminated for many years. If a need arises to use the scent pad, the lid 52 is removed and the scent pad can be retrieved.

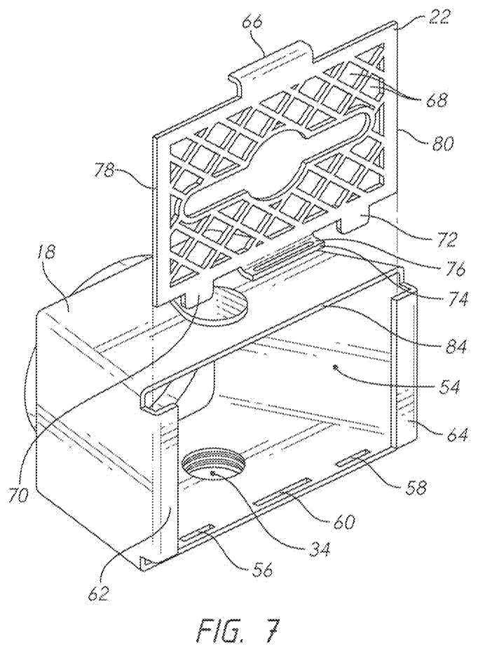

FIGS. 7-11 provide additional details regarding a preferred embodiment of the invention. Collection hood 18 is provided with attachment features to facilitate the holding of the grates. Side slot 56, side slot 58, and central slot 60 are provided in the lower portion. Vertical retainers 62, 64 are provided on the lateral sides.

Rear grate 22 includes handle 66 on its upper extreme. Lateral side 78 is sized to slide inside vertical retainer 62, while lateral side 80 is sized to slide within vertical retainer 64. Descending tab 70 on rear grate 22 is sized to slide Into side slot 56, while descending tab 72 is sized to slide into side slot 58. Forward tab 74 protrudes forward from the lower portion of the rear grate. Central slot 76 is provided in this forward tab.

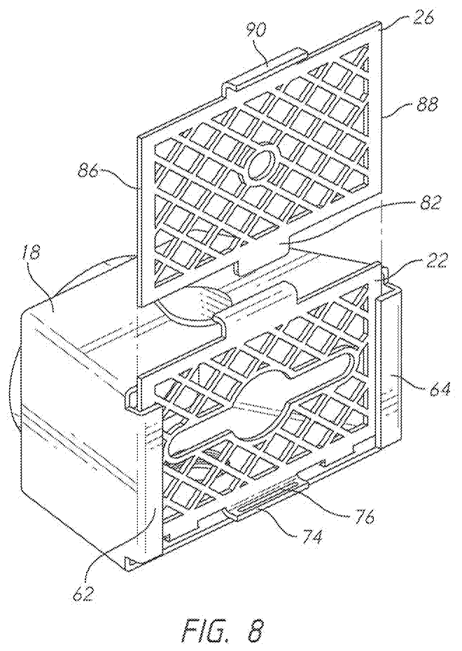

FIG. 8 shows the collection hood 18 with rear grate 22 installed. Sufficient clearance is provided by vertical retainers 62,64 so that front grate 26 can be slidably installed in front of the rear grate and behind the vertical retainers, Lateral side 86 slides into vertical retainer 62 while lateral side 88 slides into vertical retainer 64.

Handle 90 extends upward form the top of front grate 26. Descending central tab 82 extends downward from the bottom of the front grate. The descending central tab 82 is sized to slide into central slot 76 in forward tab 74. All these features in combination secure the two grates to the front of the collection hood.

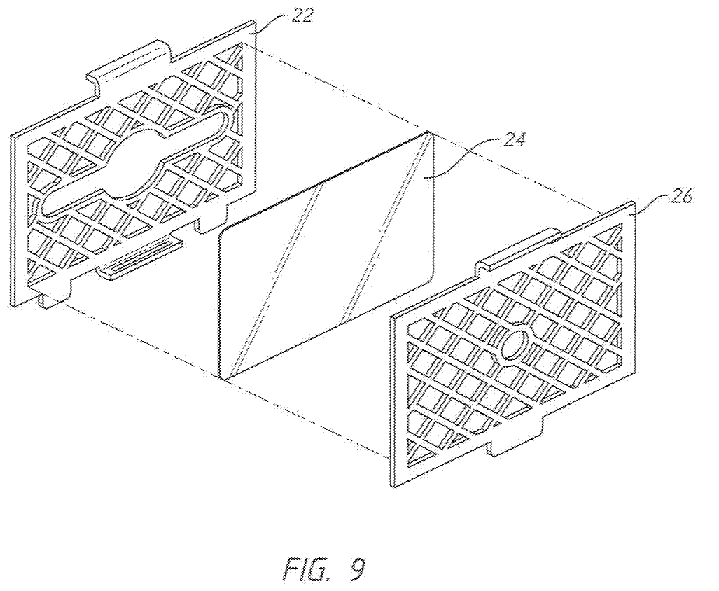

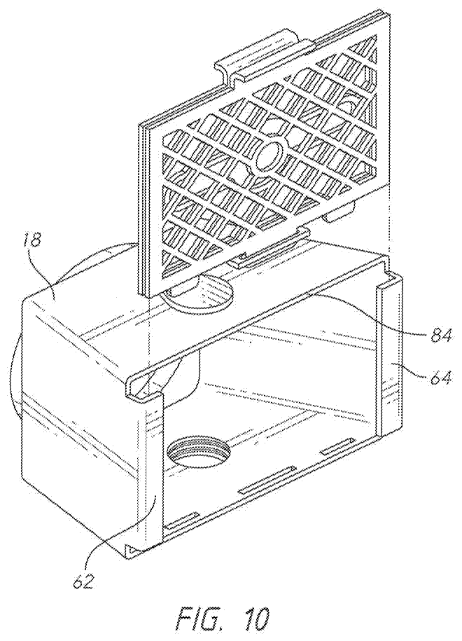

FIGS. 9-11 illustrate how the two grates will typically be used to load a scent pad in place for collection. FIG. 9 shows an exploded assembly view with scent pad 24 being positioned “sandwiched”) between rear grate 22 and front grate 26. FIG. 10 shows how the two grates and the scent pad, once assembled as a unit can be slid downwards into an installed position with the collection hood 18.

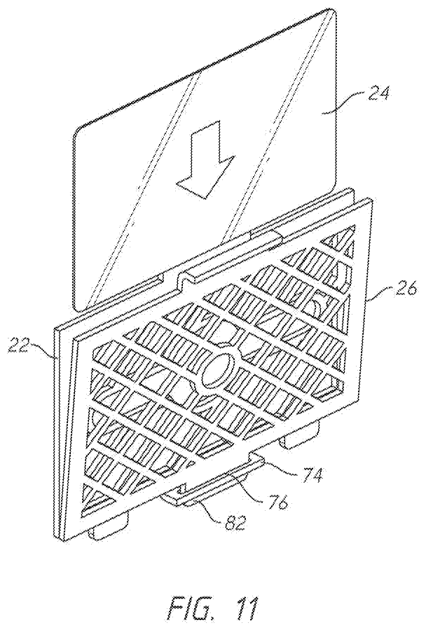

FIG. 11 shows a common assembly method. Once the grates 22, 26 are cleaned and ready for a new collection cycle, they are hooked together by placing descending central tab 82 of front grate 26 into central slot 76 in rear grate 22. The upper edges of the grates can then be urged apart as shown and a new scent pad 24 slipped in between the two grates. The assembly is then slid as a unit into engagement with the collection hood (as shown in FIG. 10).

Although the preceding descriptions contain significant detail, they should not be construed. as limiting the scope of the invention but rather as providing illustrations of the preferred embodiments of the invention. Those skilled in the art will know that many other variations are possible without departing from the scope of the invention. Accordingly, the scope of the invention should properly be determined with respect to the following claims rather than the examples given.

Having described our invention, we claim:

1. A method for collecting and storing a scent on a scent pad within a scent jar, comprising:
(a) providing a collection hood, having an interior, a first end, a second end, and a jar receiver;
(b) providing a vacuum attached to said second end of said collection hood;
(c) attaching said scent jar to said jar receiver;
(d) positioning said scent pad across said first end of said collection hood;
(e) activating said vacuum to draw air into said collection hood through said scent pad;
(f) pushing said scent pad into said interior of said collection hood and then through said jar receiver and into said scent jar; and
(g) sealing said scent jar with said scent pad inside said scent jar.

2. The method for collecting and storing a scent as recited in claim 1, further comprising:
(a) providing a rear grate removably connected to said second end of said collection hood;
(b) providing a front grate removably connected to said second end of said collection hood; and
(c) holding said scent pad between said rear and front grates

3. The method for collecting and storing a scent as recited in claim 2, further comprising:
(a) assembling said rear grate, said scent pad, and said front grate into a grate/scent pad assembly; and
(b) connecting said grate/scent pad assembly to said first side of said collection hood.

4. The method for collecting and storing a scent as recited in claim 3 wherein:
(a) said first side of said collection hood includes a first lateral channel and a second lateral channel; and
(b) said step of connecting said grate/scent pad assembly to said first side of said collection hood comprises sliding said grate/scent pad assembly into said first and second lateral channels.

5. The method for collecting and storing a scent as recited in claim 2, wherein:
(a) said front grate includes a first opening;
(b) said rear grate includes a second opening.

6. The method for collecting and storing a scent as recited in claim 5, comprising;
(a) providing a push rod; and
(b) pushing said push rod through said first and second openings in said respective front and rear grates in order to push said scent pad into said interior of said collection hood.

7. The method for collecting and storing a scent as recited in claim 6, comprising:
(a) providing a hatch opening in said collection hood;
(b) providing a hatch selectively covering said hatch opening:
(c) opening said hatch; and
(d) using said push rod to push said scent pad from said interior of said collection hood into said scent jar.

8. A method for collecting a scent on a scent pad, comprising:
(a) providing a collection hood, having an interior, a first end, and a second end;
(b) providing a vacuum attached to said second end of said collection hood;
(c) positioning said scent pad across said first end of said collection hood;
(d) activating said vacuum to draw air into said collection hood through said scent pad; and
(e) removing said scent pad and storing said scent pad.

9. The method for collecting and storing a scent as recited in claim 8, further comprising:
(a) providing a rear grate removably connected to said second end of said collection hood;
(b) providing a front grate removably connected to said second end of said collection hood; and
(c) holding said scent pad between said rear and front grates

10. The method for collecting and storing a scent as recited in claim 9, further comprising:
(a) assembling said rear grate, said scent pad, and said front grate into a grate/scent pad assembly: and
(b) connecting said grate/scent pad assembly to said first side of said collection hood.

11. The method for collecting and storing a scent as recited in claim 10 wherein:
(a) said first side of said collection hood includes a first lateral channel and a second lateral channel; and
(b) said step of connecting said grate/scent pad assembly to said first side of said collection hood comprises sliding said grate/scent pad assembly into said first and second lateral channels.

12. The method for collecting and storing a scent as recited in claim 9, wherein:
(a) said front grate Includes a first opening;
(b) said rear grate includes a second opening.

13. The method for collecting and storing a scent as recited in claim 12, comprising:
(a) providing a push rod; and
(b) pushing said push rod through said first and second openings in said respective front and rear grates in order to push said scent pad into said interior of said collection hood.

14. The method for collecting an storing a scent as recited in claim 13, comprising;
(a) providing a scent jar removably attached to said collection hood; and
(b) pushing said scent pad from said interior of said collection hood into said scent jar.

15. A method for collecting and storing a scent on a scent pad within a scent jar, comprising:
(a) providing a collection hood, having an interior, a first end, and a second end;
(b) providing a vacuum attached to said second end of said collection hood;
attaching said scent jar to said collection hood;
(d) positioning said scent pad across said first end of said collection hood;
activating said vacuum to draw air into said collection hood through said scent pad; and
pushing said scent pad into said interior of said collection hood and then into said scent jar.

16. The method for collecting and storing a scent as recited in claim 15, further comprising:
providing a rear grate removably connected to said second end of said collection hood;
b) providing a front grate removably connected to said second end of said collection hood; and
holding said scent pad between said rear and front grates

17. The method for collecting and storing a scent as recited in claim 16, further comprising:
(a) assembling said rear grate, said scent pad, and said front grate into a grate/scent pad assembly; and
(b) connecting said grate/scent pad assembly to said first side of said collection hood.

18. The method for collecting and storing a scent as recited in claim 17 wherein:
(a) said first side of said collection hood includes a first lateral channel and a second lateral channel; and
(b) said step of connecting said grate/scent pad assembly to said first side of said collection hood comprises sliding said grate/scent pad assembly into said first and second lateral channels.

19. The method for collecting and storing a scent as recited in claim 16, wherein:
(a) said front grate includes a first opening;
(b) said rear grate includes a second opening.

20. The method for collecting and storing a scent as recited in claim 19, comprising:
(a) providing a push rod; and
(b) pushing said push rod through said first and second openings in said respective front and rear grates in order to push said scent pad into said interior of said collection hood.
